(19) United States
(12) Patent Application Publication
(10) Pub. No.: US 2020/0001682 A1
(43) Pub. Date: Jan. 2, 2020

(54) SYSTEM FOR COOLING VEHICLE ELECTRIC COMPONENT

(71) Applicant: Hanon Systems, Daejeon (KR)

(72) Inventors: Hae Jun LEE, Daejeon (KR); Seong Hun KIM, Daejeon (KR); Sung Je LEE, Daejeon (KR)

(73) Assignee: Hanon Systems, Daejeon (KR)

(21) Appl. No.: 16/301,095

(22) PCT Filed: Jan. 11, 2018
(86) PCT No.: PCT/KR2018/000523

§ 371 Date: Nov. 13, 2018

(30) Foreign Application Priority Data
Mar. 24, 2017 (KR) 10-2017-0037815

(51) Int. Cl. B60H 1/00; B60H 1/32

(52) U.S. Cl. CPC B60H 1/00271; B60H 1/00028; B60H 1/00392; B60H 1/00428; B60H 1/3208; B60H 2001/00185; B60H 1/3227; B60H 1/3229; B60H 1/32281; B60H 1/00492; B60H 1/3222

(57) ABSTRACT

The present invention relates to a system for cooling a vehicle electric component including: a compressor compressing a refrigerant; a condenser connected to the compressor to condense the refrigerant supplied from the compressor and formed to surround an outer periphery of the compressor; an expansion means connected to the condenser to expand the refrigerant supplied from the condenser; an evaporator connected to the expansion means and the compressor to evaporate the refrigerant supplied from the expansion means by a heat exchange and then introduce the evaporated refrigerant into the compressor; and a blower fan disposed on one side or the other side of the condenser which is opened, wherein the system for cooling a vehicle electric component may effectively cool electric components such as a variety of sensors and computers of an autonomous vehicle and may secure a sufficient cooling performance by using a vapor compression system.

### TECHNICAL FIELD

The present invention relates to a system for cooling a vehicle electric component for cooling electric components such as a variety of sensors and computers and the like used in an autonomous vehicle.

### BACKGROUND ART

An autonomous vehicle refers to an automobile that automatically runs by recognizing the condition of a road without a driver controlling a brake, a steering wheel, and an accelerator pedal, and the like.

Examples of a key technology for implementing the autonomous vehicle include a highway driving assist (HDA) technology that automatically maintains a distance between vehicles, a bind spot detection (BSD) system that detects nearby vehicles in the backward direction and sounds an alarm, an autonomous emergency braking (AEB) system that operates a braking system when a front vehicle is not recognized, a lane keeping assist system (LKAS) that compensates for lane departure without a turn signal, and Advanced Smart Cruise Control (ASCC), which maintains the distance between vehicles at a set speed and drives at a fixed speed, and a traffic jam assist (TJA) system.

In recent years, as the level of the autonomous vehicle is increased, cooling loads of sensors such as a radar capable of detecting an object and measuring a distance from an object using an electromagnetic wave, a lidar capable of measuring a shape of the object and the distance from the object using laser, and the like, and processors such as a central processing unit (CPU), a graphic processing unit (GPU), and the like are increased.

However, cooling systems based on air-cooled or water-cooled systems, such as conventional radiators, have limitations in cooling electric components such as the sensors and the processors.

Therefore, there is a need for a cooling system capable of effectively cooling the electric components of the autonomous vehicle using a vapor compression system.

### RELATED ART DOCUMENT

### Patent Document

Korean Patent No. 10-1551701 B1 (2015.09.03)

### DISCLOSURE

### Technical Solution

An object of the present invention is to provide a system for cooling a vehicle electric component capable of effectively cooling electric components such as a variety of sensors and computers of an autonomous vehicle using a vapor compression system.

In one general aspect, a system for cooling a vehicle electric component includes: a compressor 100 compressing a refrigerant; a condenser 200 connected to the compressor 100 to condense the refrigerant supplied from the compressor 100 and formed to surround an outer periphery of the compressor 100; an expansion means 300 connected to the condenser 200 to expand the refrigerant supplied from the condenser 200; an evaporator 400 connected to the expansion means 300 and the compressor 100 to evaporate the refrigerant supplied from the expansion means 300 by a heat exchange and then introduce the evaporated refrigerant into the compressor 100; and a blower fan 500 disposed on one side or the other side of the condenser 200 which is opened.

The system for cooling a vehicle electric component may further include a case 600 having the compressor 100, the condenser 200, and the expansion means 300 accommodated in an inner space thereof, having a plurality of vents 610 formed therein, and having the blower fan 500 coupled to an opened upper side thereof.

The blower fan 500 may be an axial fan or a centrifugal fan.

The condenser 200 may be formed so that a tube 210 in which the refrigerant flows is formed in a spiral shape or a “ [symbol] ” shape to surround an outer periphery of the compressor 100.

The tube 210 may be formed to surround the entire or a portion of the outer periphery of the compressor 100.

The expansion means 300 may be disposed in an inner side surrounded by the condenser 200.

The condenser 200 may include a tube 210 in which the refrigerant flows, and a plurality of fins 220 coupled to the tube 210, and the fins 220 may be formed in a disk shape such that the respective fins 220 may be coupled to one tube 210 and arranged to be apart from each other along the tube 210.

The condenser 200 may include a tube 210 in which the refrigerant flows, and a plurality of fins 220 coupled to the tube 210, and the fins 220 may be formed in a rectangular plate shape such that the respective fins 220 may be coupled to a plurality of tubes 210 and arranged to be apart from each other along a circumferential direction.

The evaporator 400 may be formed in a plate shape and a passage in which the refrigerant flows may be formed in the evaporator 400.

One evaporator 400 may be formed, and the evaporator 400 may be connected to the expansion means 300 by a refrigerant inflow pipe 700 and be connected to the compressor 100 by a refrigerant discharge pipe 800.

A plurality of evaporators 400 may be formed, and the system for cooling a vehicle electric component may further include a distributor 900 connected to the expansion means 300 by one refrigerant inflow pipe 700 and connected to the compressor 100 by one refrigerant discharge pipe 800, such that the respective evaporators 400 may be connected to the distributor 900 by an inflow distribution pipe 710 and a discharge confluent pipe 810.

The system for cooling a vehicle electric component may further include a buffer chamber 250 connected between a rear end of the condenser 200 and a front end of the expansion means 300 in a flow direction of the refrigerant.

The system for cooling a vehicle electric component may further include an accumulator 450 connected between a rear end of the evaporator 400 and a front end of the compressor 100 in the flow direction of the refrigerant.

### Advantageous Effects

The system for cooling a vehicle electric component according to the present invention may effectively cool the electric components such as a variety of sensors and computers of the autonomous vehicle and may secure a sufficient cooling performance by using the vapor compression system.

### DESCRIPTION OF DRAWINGS

FIGS. 1 and 2 are an assembly perspective view and an exploded perspective view showing a system for cooling a vehicle electric component according to an exemplary embodiment of the present invention.

FIG. 3 is an assembly perspective view showing a compressor, a condenser, and an expansion valve according to an exemplary embodiment of the present invention.

FIG. 4 is a perspective view showing a state in which the condenser is removed from FIG. 3.

FIGS. 5 and 6 are front views showing a flow direction of cooled air when an air blower is an axial fan according to the present invention.

FIG. 7 is a front view showing a flow direction of cooled air when an air blower is a centrifugal fan according to the present invention.

FIG. 8 is an assembly perspective view showing a compressor, a condenser, and an expansion valve according to another exemplary embodiment of the present invention.

FIG. 9 is a perspective view showing another form of the condenser according to the present invention.

FIG. 10 is a perspective view showing an example in which a plurality of electric components are in contact with one evaporator and are cooled according to the present invention.

FIG. 11 is a perspective view showing an example in which the electric components are each in contact with a plurality of evaporators and are cooled according to the present invention.

### BEST MODE

Hereinafter, a system for cooling a vehicle electric component according to the present invention having a configuration as described above will be described in detail with reference to the accompanying drawings.

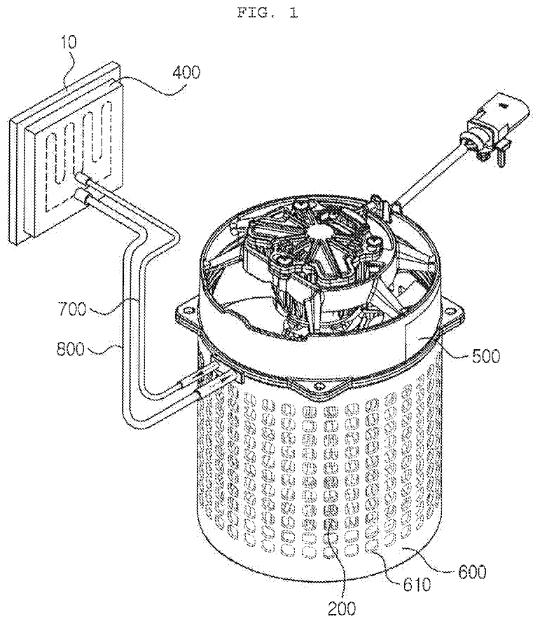

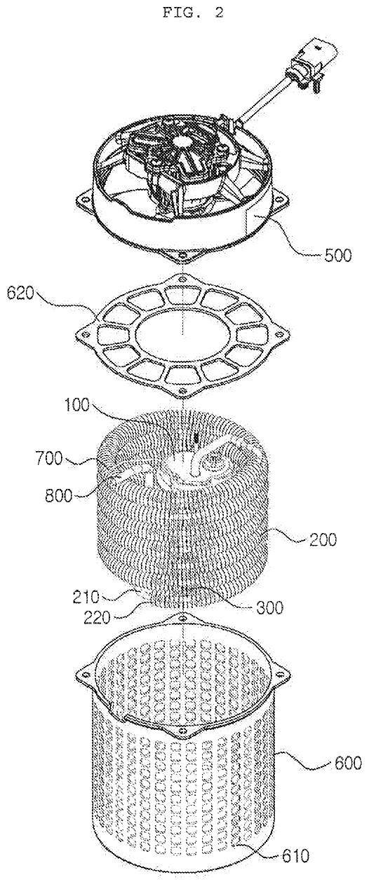

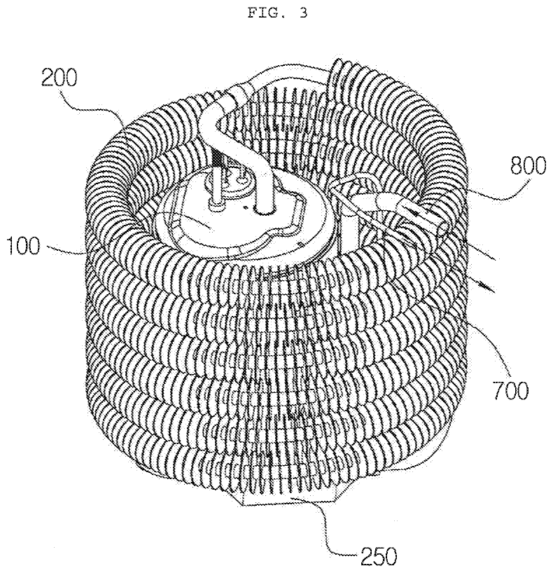

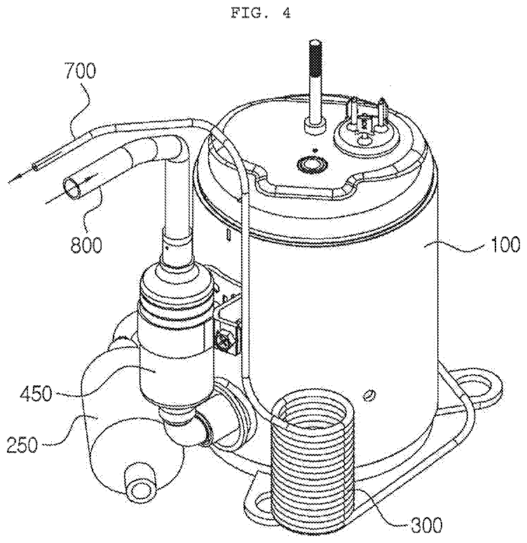

FIGS. 1 and 2 are an assembly perspective view and an exploded perspective view showing a system for cooling a vehicle electric component according to an exemplary embodiment of the present invention, FIG. 3 is an assembly perspective view showing a compressor, a condenser, and an expansion valve according to an exemplary embodiment of the present invention, and FIG. 4 is a perspective view showing a state in which the condenser is removed from FIG. 3.

As shown in the drawings, a system for cooling a vehicle electric component according to the present invention may include a compressor 100 compressing a refrigerant; a condenser 200 connected to the compressor 100 to condense the refrigerant supplied from the compressor 100 and formed to surround an outer periphery of the compressor 100; an expansion means 300 connected to the condenser 200 to expand the refrigerant supplied from the condenser 200; an evaporator 400 connected to the expansion means 300 and the compressor 100 to evaporate the refrigerant supplied from the expansion means 300 by a heat exchange and then introduce the evaporated refrigerant into the compressor 100; and a blower fan 500 disposed on one side or the other side of the condenser 200 which is opened.

First, the system for cooling a vehicle electric component may generally include the compressor 100, the condenser 200, the expansion means 300, the evaporator 400, and the blower fan 500, and may be formed to cool sensors or processors disposed to be in contact with the evaporator 400 through a vapor compression system using a refrigerant.

The compressor 100 may be driven by receiving power from a motor, which is a power supplying source, and serves to suck and compress a gaseous refrigerant discharged from the evaporator 400 and send the gaseous refrigerant to the condenser 200. In addition, the compressor 100 may be formed in a standing cylindrical shape with upper and lower ends thereof closed, and may be formed so that the refrigerant flows into a lower side thereof, is compressed, and is then discharged through an upper side thereof.

The condenser 200 serves to exchange heat between a high-pressure gaseous refrigerant discharged from the compressor 100 and outside air, condense the refrigerant into liquid, and send the condensed liquid to the expansion means 300. In addition, the condenser 200 may be formed to surround an outer periphery of the compressor 100 formed in the cylindrical shape, and as an example, as shown, the condenser 200 may surround an outer periphery except for the upper side and the lower side of the compressor 100. Here, the condenser 200 is formed in a shape in which a tube 210 in which the refrigerant may flow is wound around a central axis at a position spaced apart from the outer circumferential surface of the compressor 100, and the entire shape in which the tube 210 is wound may be formed in a cylindrical shape or a cylindrical shape in which a part of the cylindrical shape is opened. In addition, a plurality of fins 220 may be coupled to an outer surface of the tube 210 to improve heat exchange efficiency, and the fins 220 may be arranged to be spaced apart from each other along a length direction or a circumference direction in which the tube 210 extends. In addition, the condenser 200 may be variously formed in a form surrounding the outer periphery of the compressor 100 and may be formed in various forms in which the outside air passes through the condenser 200 and the heat exchange may be performed.

The expansion means 300 serves to rapidly expand a high-pressure liquid-phase refrigerant discharged from the condenser 200 by using a throttling action to bring the refrigerant into a low-temperature, low-pressure, and wet saturated state, and send it to the evaporator 400. Here, the expansion means 300 may be formed with an expansion passage having an orifice to expand the refrigerant flowing from the condenser 200 to the evaporator 400, and as shown, may be formed of a capillary tube formed by winding a tube having a diameter smaller than that of the tube 210 of the condenser 200 in the form of a coil spring. In addition, the expansion means 300 may be variously formed, and may also be formed of an expansion valve including a flow control valve capable of controlling a flow rate of the flowing refrigerant in addition to the capillary.

The evaporator 400 evaporates the liquid-phase refrigerant by exchanging heat between the low-pressure liquid-phase refrigerant throttled by the expansion means 300 and a heat exchange target object, thereby cooling the heat exchange target object with an endothermic action by evaporative latent heat of the refrigerant. Here, a refrigerant passage through which the refrigerant may flow is formed in the evaporator 400, such that the refrigerant introduced from the expansion means 300 flows along the refrigerant passage in the evaporator 400 and is then discharged and the discharged refrigerant may be again introduced into the compressor 100. In this case, the evaporator 400 may be, for example, a cold plate in which the refrigerant passage is formed, and the electric components 10, such as sensors such as a radar and a lidar of an autonomous vehicle or processors such as a central processing unit (CPU) and a graphic processing unit (GPU may be disposed to be in contact with the evaporator 400. That is, the heat exchange target object that exchanges heat with the refrigerant of the evaporator 400 may be the electric component 10, and the evaporator 400 may be formed in various forms so that it may be in contact with the electric component 10 and the heat exchange may be smoothly performed by thermal conduction. In addition, the gaseous refrigerant which is heat-exchanged and evaporated by the evaporator 400 may be sucked and compressed again by the compressor 100 to be formed into a high-pressure gaseous state and sent to the condenser 200, and a cycle as described above is repeated.

The blower fan 500 may be disposed on one side or the other side of the condenser 200 which is opened, such that the condenser 200 may be cooled by operating the blower fan 500 to allow the outside air to flow. That is, the blower fan 500 may be disposed on the opened upper side (or lower side) of the condenser 200 having an entire outer shape formed in a cylindrical shape as shown, and when the blower fan 500 is operated, air passes through the condenser 200 while flowing from a radial outside to a radial inside of the condenser 200, and then flows upwardly while passing between the condenser 200 and the compressor 100, such that the air may be discharged to an upper portion of the blower fan 500 through the blower fan 500. Alternatively, when the blower fan 500 is operated, the air flows downwardly from the upper portion of the blower fan 500, passes through the blower fan 500, flows downwardly while passing between the condenser 200 and the compressor 100, and then passes through the condenser 200 while flowing from the radial inside to the radial outside of the condenser 200, such that the air may be discharged externally from the outer periphery of the condenser 200. Here, a lower end of the cylindrical condenser 200 may be closed or opened, and a lower side thereof may be surrounded and closed with a case 600 to be described below.

Therefore, the system for cooling a vehicle electric component according to the present invention may be configured as one independent vapor compression cooling system, and since the compressor, the condenser, the expansion valve, and the blower fan may be integrally and compactly configured, they may be each easily installed to be adjacent to the electric components such as a variety of sensors or processors having a large thermal load in the autonomous vehicle. In addition, the sensor sensing a distance such as a radar or a lidar of the autonomous vehicle is mounted in various positions of the vehicle, and the system for cooling a vehicle electric component according to the present invention may be installed to be adjacent to the electric components and may have a short length of a pipe in which the refrigerant flows, thereby improving cooling efficiency. In addition, since the electric components may be cooled by using a vapor compression cooling system instead of a method of cooling electric components by using a heat exchanger such as an air-cooled or water-cooled radiator, the sensors or the processors of the autonomous vehicle that requires a large cooling capacity according to a high specification may be sufficiently cooled.

In addition, the system for cooling a vehicle electric component according to the present invention may further include a case 600 having the compressor 100, the condenser 200, and the expansion means 300 accommodated in an inner space thereof, having a plurality of vents 610 formed therein, and having the blower fan 500 coupled to an opened upper side thereof.

That is, since the system for cooling a vehicle electric component according to the present invention further includes the case 600, the compressor 100, the condenser 200, and the expansion means 300 may be accommodated in the case 600 in which the plurality of vents 600 through which air may pass are formed.

In addition, the case 600 includes a cylindrical body and a lower plate formed to close a lower side of the body, such that the lower side of the body may be formed in a closed container shape and an upper side thereof may be formed in an opened shape, and the plurality of vents 610 may be formed in the cylindrical body of the case 600 so as to penetrate through both sides of the body. In addition, the blower fan 500 is coupled to the opened upper side of the cylindrical body of the case 600 such that the compressor 100, the condenser 200, and the expansion means 300 may be entirely surrounded by the case 600 and the blower fan 500. In this case, the compressor 100 may be coupled and fixed to the lower plate of the case 600, and a partially cut opening is formed in the cylindrical body of the case 600 such that a refrigerant inflow pipe 700 connecting the expansion means 300 and the evaporator 400 with each other and a refrigerant discharge pipe 800 connecting the compressor 100 and the evaporator 400 with each other may be led out from the case 600 through the opening. In addition, an upper plate 620 may be coupled to the opened upper side of the case 600 and the blower fan 500 may be coupled to an upper side of the upper plate 620, and a plurality of openings penetrating through upper and lower surfaces of the upper plate 620 may be formed in the upper plate 620 so that air may pass therethrough.

As a result, the compressor, the condenser, and the expansion means may be accommodated in the case and may be fixed thereto, and an outer surface of the condenser may also be supported by the case. In addition, the blower fan may be fixed to the case, and the upper side of the condenser may also be supported by the upper plate of the case.

In addition, the blower fan 500 may be an axial fan or a centrifugal fan.

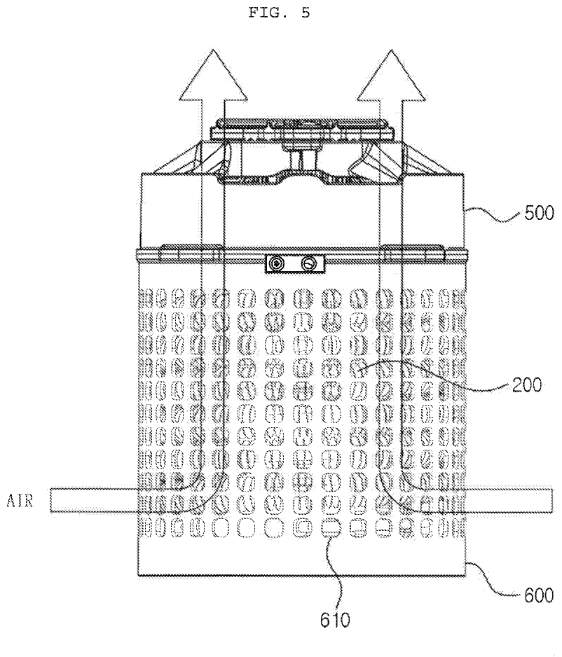

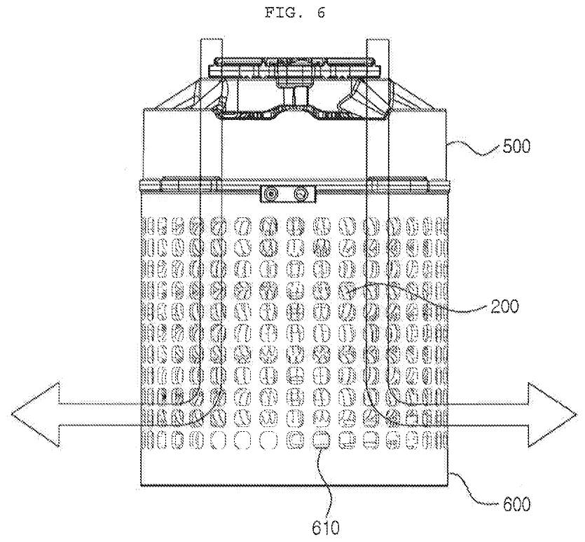

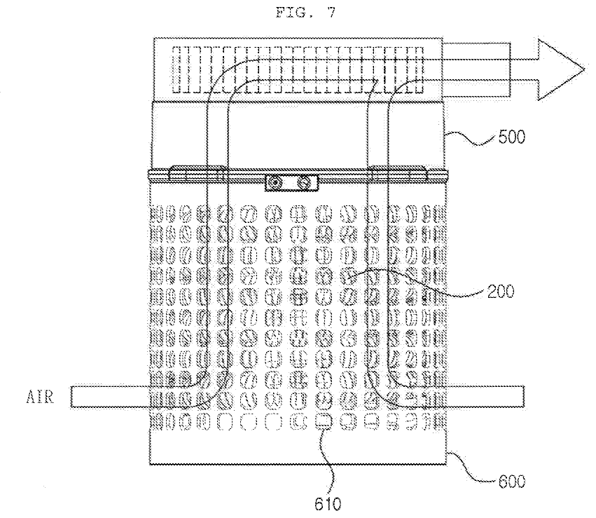

That is, as the blower fan 500, an axial fan configured to allow air to pass through the fan in a direction of a rotation axis of the fan or a centrifugal fan (a centrifugal blower) configured to introduce air in the direction of the rotation axis of the fan and to be radially outward of the fan may be used. In addition, in both the case in which axis fan is used and the case in which the centrifugal fan is used, the blower fan 500 may be configured to blow air toward the condenser 200 from the blower fan 500 or to suck air from the condenser 200 toward the blower fan 500. Therefore, in the case in which the axial fan is used, cooled air may flow as shown in FIGS. 5 and 6, and in the case in which the centrifugal fan is used, cooled air may flow as shown in FIG. 7.

In addition, the condenser 200 may be formed so that the tube 210 in which the refrigerant flows is formed in a spiral shape or a “ [symbol] ” shape to surround an outer periphery of the compressor 100.

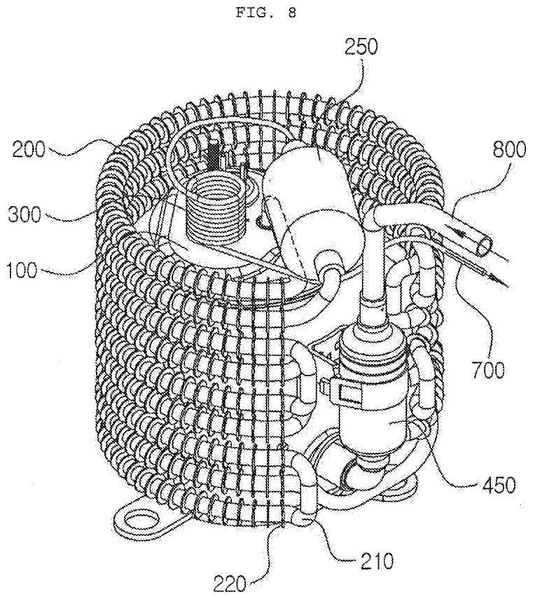

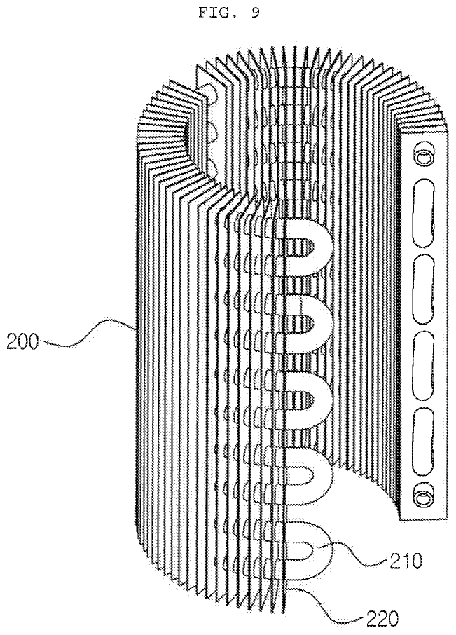

That is, as shown in FIGS. 2 and 3, the condenser 200 may be formed in a spiral shape in which the tube 210 through which the refrigerant flows is wound in a coil spring shape, so that the tube 210 surrounds the outer circumference of the compressor 100. Alternatively, as shown in FIGS. 8 and 9, the condenser may be formed to surround the outer circumference of the compressor 100 by forming the tube 210 of a “ [symbol] ” shape in a repeated and connected form. In this case, in FIG. 8, a downward passage tube 210 of the “ [symbol] ” shape in which the refrigerant discharged from an upper side of the compressor 100 flows downwardly is formed, an upward passage tube 210 of the “ [symbol] ” shape that allows the refrigerant to flow upwardly again at an end of the downward passage tube is disposed and connected between the downward passage tubes 210, and the upward passage tubes and the downward passage tube are alternately disposed so as not be overlapped with each other. As a result, an inlet pipe in which the refrigerant is introduced into the condenser 200 and an outlet pipe through which the refrigerant passes through the condenser 200 and discharged may be disposed at the upper side and may be disposed at positions which are adjacent to each other, such that the condenser 200 may be easily connected and disposed with the compressor 100 and the expansion means 300. Here, the upward passage tubes are odd-numbered tubes from the upper side to the lower side on the drawing and the downward passage tubes are even-numbered tubes from the upper side to the lower side. Besides, the tube 210 of the condenser 200 may be variously formed to surround the outer periphery of the compressor 100.

In addition, the tube 210 may be formed to surround the entire or a portion of the outer periphery of the compressor 100.

That is, as shown in FIGS. 2 and 3, the tube 210 of the condenser 200 may be formed to surround the entire outer circumference except for the upper side and the lower side of the compressor 100. Here, as shown in FIG. 8, in a case in which an accumulator 450 and the like are disposed on the outer circumferential surface of the compressor 100, the tube 210 of the “ [symbol] ” shape is formed such that the tube 210 may be formed to surround an outer periphery of the compressor 100 except for a portion in which the accumulation 450 is disposed. Therefore, the condenser 200 may be formed in a compact structure by forming an outer diameter of the condenser 200 with the smallest size. In this case, the expansion means 300 and a buffer chamber 250 may be disposed on an inner side of the condenser 200 and an upper side of the compressor 100, and the expansion means 300 or the buffer chamber 250 may also be disposed on an outer circumferential surface of the compressor 100 in which the tube 210 is not present. Alternatively, the tube 210 may also be formed so as to surround the entire outer circumference of the compressor 100 including the accumulator 450 disposed on the outer circumferential surface of the compressor 100 by forming the tube 210 in a spiral shape as shown in FIGS. 3 and 4.

Therefore, the tube 210 has a larger outer diameter than the tube 210 of the above mentioned “E” shape, but may be formed in a simple shape, and the expansion means 300 and the buffer chamber 250 may be disposed in an empty space between the inner side of the tube 210 and the outer periphery of the compressor 100, thereby making it possible to reduce the entire length in a vertical direction as compared to the exemplary embodiment of the above-mentioned “ [symbol] ” shaped tube.

In addition, the expansion means 300 may be disposed in the inner side surrounded by the condenser 200.

That is, since the expansion means 300 is disposed in the inner space surrounded by the condenser 200 as described above, a more compact configuration is possible, and the buffer chamber 250 in which the refrigerant is temporarily stored before the refrigerant is pressurized to the expansion means 300 and capable of serving to separate a gaseous refrigerant which is partially included in the liquid refrigerant may also be disposed in the inner side of the condenser 200 to be adjacent to the expansion means 300.

In addition, the condenser 200 may include a tube 210 in which the refrigerant flows, and a plurality of fins 220 coupled to the tube 210, and the fins 220 may be formed in a disk shape such that the respective fins 220 may be coupled to one tube 210 and arranged to be apart from each other along the tube 210.

That is, as shown, the condenser 200 may include a tube 210 of a pipe shape and a plurality of fins 220 for improving heat exchange efficiency, and a plurality of disk fins 220 may be coupled to the tube 210 so that they may be spaced apart from each other and arranged along a length direction in which the tube 210 extends. In this case, each of the disk fins 220 may be coupled to only one tube 210.

In addition, the condenser 200 may include a tube 210 in which the refrigerant flows, and the plurality of fins 220 coupled to the tube 210, and the fins 220 may be formed in a rectangular plate shape such that the respective fins 220 may be coupled to a plurality of tubes 210 and arranged to be apart from each other along a circumferential direction.

That is, as shown in FIG. 9, the fins 220 are formed in a vertically elongated rectangular plate shape, such that one fin 220 may be coupled to the plurality of tubes 210 and the plurality of fins 220 may be arranged to be apart from each other along the circumferential direction. Therefore, air may easily pass through the condenser 200 in the radial direction and may easily flow in the vertical direction. In addition, since the positions of the tubes 210 may be fixed by the fins 220, the condenser 200 may be more firmly formed.

In addition, the evaporator 400 may be formed in a plate shape and a passage in which the refrigerant flows may be formed in the evaporator 400.

That is, the evaporator 400 is formed in the plate shape so that it may be contact with the electric component 10 such as the sensor or the processor of the autonomous vehicle to perform a heat exchange by thermal conduction, and the passage may be formed in the evaporator so that the refrigerant may flow. In addition, one side of the passage in which the refrigerant flows may be connected to the expansion means 300 by the refrigerant inflow pipe 700, and the other side of the passage may be connected to the compressor 100 by the refrigerant discharge pipe 800.

In addition, one evaporator 400 is formed, and the evaporator 400 may be connected to the expansion means 300 by the refrigerant inflow pipe 700 and may be connected to the compressor 100 by the refrigerant discharge pipe 800.

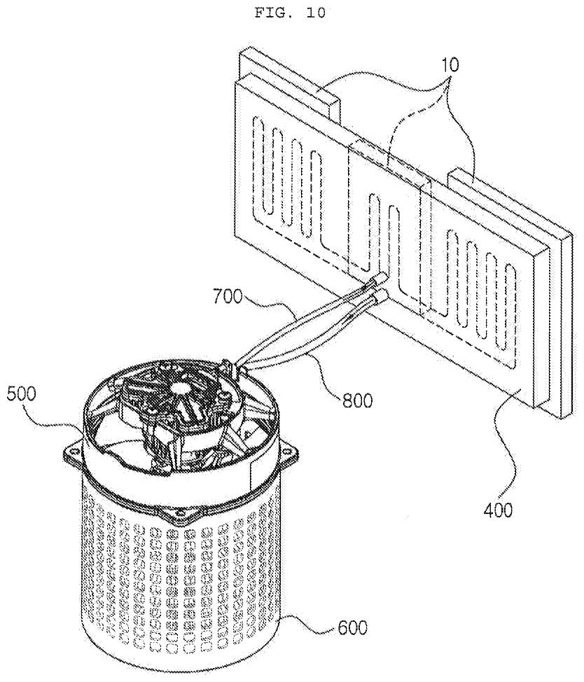

That is, as shown in FIG. 10, since one evaporator 400 is formed, the evaporator 400 and the expansion means 300 may be connected to each other by a single refrigerant inflow pipe 700, and the evaporator 400 and the compressor 100 may be connected to each other by a single refrigerant discharge pipe 800. In this case, one electric component 10 may be mounted on the evaporator 400, but since the evaporator 400 is formed in a rectangular plate shape, a plurality of electric components 10 may be in contact with and mounted on the evaporator 400.

Therefore, the plurality of electric components 10 may be cooled by using one evaporator 400, and since a single refrigerant inflow pipe 700 and a single refrigerant discharge pipe 800 are formed, the entire cooling system may be easily controlled.

In addition, a plurality of evaporators 400 may be formed, and the system for cooling a vehicle electric component may further include a distributor 900 connected to the expansion means 300 by one refrigerant inflow pipe 700 and connected to the compressor 100 by one refrigerant discharge pipe 800, such that the respective evaporators 400 may be connected to the distributor 900 by an inflow distribution pipe 710 and a discharge confluent pipe 810.

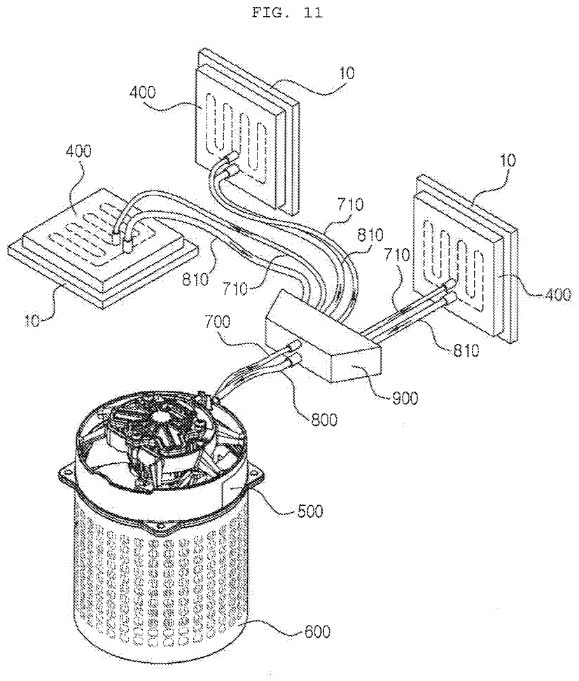

That is, as shown in FIG. 11, the plurality of evaporators 400 are formed such that the electric component 10 may be in contact with and mounted on each of the evaporators 400, and the refrigerant inflow pipe 700 and the refrigerant discharge pipe 800 may be each connected to the evaporators 400. In addition, in order to connect the plurality of evaporators 400 to each other, the distributor 900 may be used, and the distributor 900 may be connected to the expansion means 300 by one refrigerant inflow pipe 700 and may be connected to the compressor 100 by one refrigerant discharge pipe 800. In addition, the respective evaporators 400 may be connected to the distributor 900 by the inflow distribution pipe 710 so that the distributor 900 may distribute and supply the refrigerant to the plurality of evaporators 400, and the respective evaporators 400 may be connected to the distributor 900 by the discharge confluent pipe 810 so that the refrigerant supplied to the evaporators 400 may be collected and sent to the compressor 100. Therefore, as compared to a case in which the evaporators 400 are directly connected to the expansion means 300 and the compressor 100 by the refrigerant inflow pipe and the refrigerant discharge pipe, respectively, after the refrigerant introduced through one refrigerant inflow pipe 700 from the expansion means 300 is distributed by the distributor 900 and is supplied to the evaporators 400, the collected refrigerant is combined and is sent to the compressor 100 through one refrigerant discharge pipe 800, which is a single passage, thereby making it possible to easily control the entire cooling system and to easily adjust or control a flow rate of the refrigerant distributed into the evaporators.

In addition, the system for cooling a vehicle electric component may further include a buffer chamber 250 connected between a rear end of the condenser 200 and a front end of the expansion means 300 in a flow direction of the refrigerant.

That is, the buffer chamber 250 is a space in which the refrigerant may be temporarily stored before the refrigerant passing through the condenser 200 is introduced into the expansion means 300, and may serve to separate the gaseous refrigerant which may be partially included in the liquid refrigerant.

In addition, the system for cooling a vehicle electric component may further include an accumulator 450 connected between a rear end of the evaporator 400 and a front end of the compressor 100 in the flow direction of the refrigerant.

That is, the accumulator 450 may temporarily store and axially compress the refrigerant before the gaseous refrigerant is introduced into the compressor 100 after the refrigerant is evaporated and heat-exchanged in the evaporator 400, and may maintain a pressure in a refrigerant passage and reduce pulsation. In addition, the accumulator 450 may also serve to separate the gaseous refrigerant and the liquid refrigerant from each other.

The present invention is not limited to the above-mentioned exemplary embodiments but may be variously applied, and may be variously modified by those skilled in the art to which the present invention pertains without departing from the gist of the present invention claimed in the claims.

### DETAILED DESCRIPTION OF MAIN ELEMENTS

10: electric component
100: compressor
200: condenser
210: tube
220: fin
250: buffer chamber
300: expansion means
400: evaporator
450: accumulator
500: blower fan
600: case
610: vent
620: upper plate
700: refrigerant inflow pipe
710: inflow distribution pipe
800: refrigerant discharge pipe
810: discharge confluent pipe
900: distributor

1. A system for cooling a vehicle electric component comprising:
a compressor compressing a refrigerant;
a condenser connected to the compressor to condense the refrigerant supplied from the compressor and formed to surround an outer periphery of the compressor;
an expansion means connected to the condenser to expand the refrigerant supplied from the condenser;
an evaporator connected to the expansion means and the compressor to evaporate the refrigerant supplied from the expansion means by a heat exchange and then introduce the evaporated refrigerant into the compressor; and
a blower fan disposed on one side or the other side of the condenser which is opened.

2. The system for cooling a vehicle electric component of claim 1, further comprising a case having the compressor, the condenser, and the expansion means accommodated in an inner space thereof, having a plurality of vents formed therein, and having the blower fan coupled to an opened upper side thereof.

3. The system for cooling a vehicle electric component of claim 1, wherein the blower fan is an axial fan or a centrifugal fan.

4. The system for cooling a vehicle electric component of claim 1, wherein the condenser is formed so that a tube in which the refrigerant flows is formed in a spiral shape or a “ [symbol] ” shape to surround an outer periphery of the compressor.

5. The system for cooling a vehicle electric component of claim 4, wherein the tube is formed to surround the entire or a portion of the outer periphery of the compressor.

6. The system for cooling a vehicle electric component of claim 1, wherein the expansion means is disposed in an inner side surrounded by the condenser.

7. The system for cooling a vehicle electric component of claim 1, wherein the condenser includes a tube in which the refrigerant flows, and a plurality of fins coupled to the tube, and
the fins are formed in a disk shape such that the respective fins are coupled to one tube and arranged to be apart from each other along the tube.

8. The system for cooling a vehicle electric component of claim 1, wherein the condenser includes a tube in which the refrigerant flows, and a plurality of fins coupled to the tube, and
the fins are formed in a rectangular plate shape such that the respective fins are coupled to a plurality of tubes and arranged to be apart from each other along a circumferential direction.

9. The system for cooling a vehicle electric component of claim 1, wherein the evaporator is formed in a plate shape and a passage in which the refrigerant flows is formed in the evaporator.

10. The system for cooling a vehicle electric component of claim 1, wherein one evaporator is formed, and
the evaporator is connected to the expansion means by a refrigerant inflow pipe and is connected to the compressor by a refrigerant discharge pipe.

11. The system for cooling a vehicle electric component of claim 1, wherein a plurality of evaporators are formed, and
the system for cooling a vehicle electric component further includes a distributor connected to the expansion means by one refrigerant inflow pipe and connected to the compressor by one refrigerant discharge pipe, such that the respective evaporators are connected to the distributor by an inflow distribution pipe and a discharge confluent pipe.

12. The system for cooling a vehicle electric component of claim 1, further comprising a buffer chamber connected between a rear end of the condenser and a front end of the expansion means in a flow direction of the refrigerant.

13. The system for cooling a vehicle electric component of claim 1, further comprising an accumulator connected between a rear end of the evaporator and a front end of the compressor in the flow direction of the refrigerant.
